(19) United States
(12) Patent Application Publication
(10) Pub. No.: US 2026/0070395 A1
(43) Pub. Date: Mar. 12, 2026

(54) AUTOMOTIVE AIR VENT

(71) Applicants: HYUNDAI MOTOR COMPANY, Seoul (KR); KIA CORPORATION, Seoul (KR); ITW EF&C Korea LLC., Incheon (KR); HYUNDAI MOBIS CO., LTD., Seoul (KR)

(72) Inventors: Jae Woo Lee, Hwaseong-si (KR); Uug Hwi Kim, Hwaseong-si (KR); Gee Young Shin, Hwaseong-si (KR); Seung Won Jung, Hwaseong-si (KR); Chun Ha Kim, Seoul (KR); Byung Jo Kim, Incheon (KR); Seung Cheol Kim, Suwon-si (KR)

(73) Assignees: HYUNDAI MOTOR COMPANY, Seoul (KR); KIA CORPORATION, Seoul (KR); ITW EF&C Korea LLC., Incheon (KR); HYUNDAI MOBIS CO., LTD., Seoul (KR)

(21) Appl. No.: 19/076,559

(22) Filed: Mar. 11, 2025

(30) Foreign Application Priority Data
Sep. 6, 2024 (KR) 10-2024-0121271

(51) Int. Cl. B60H 1/34

(52) U.S. Cl. CPC B60H 1/3414; B60H 2001/3471

(57) ABSTRACT

An automotive air vent includes: a housing having open front and rear portions, and an air vent mounted inside the housing and configured to move in a front-to-back direction. and the air vent includes a blade and a knob for adjusting a wind direction. The automotive air vent further includes a mesh cover installed in a divided manner inside the housing and configured to cover the air vent so that wind is discharged at a reduced wind speed. In particular, the mesh cover is configured to guide the air vent to selectively move forward when the mesh cover is retracted into the housing for switching from a no-wind mode to an air vent mode.

### CROSS REFERENCE TO RELATED APPLICATION

This application claims priority to Korean Patent Application No. 10-2024-0121271, filed Sep. 6, 2024, the entire contents of which are incorporated herein by reference.

### BACKGROUND

### Technical Field

The present disclosure relates to an automotive air vent and, more particularly, to an automotive air vent configured to be selectively switched to a no-wind mode or a normal ventilation mode to improve indoor comfort.

### Description of the Related Art

In general, a vehicle is provided with a heating, ventilation, and air conditioning (HVAC) system to generate and supply cold or warm air to the interior of the vehicle for cooling or heating, or to maintain the interior in a comfortable condition regardless of the outside environment, and the vehicle is also provided with air vents to regulate or control an amount and a direction of air discharged by such an air conditioning system.

In a conventional air vent device, a plurality of horizontal blades and vertical blades are arranged as a grid in an overlapping manner in a duct housing having open front and rear portions.

These horizontal and vertical blades are configured to pivot to change the direction of the discharged wind, and in this regard, a user-adjustable knob is provided to operate in coordination with the horizontal and vertical blades.

On the other hand, cold air from the air conditioning system provides rapid cooling in the early stage of air conditioning to provide a comfortable feeling. However, in the middle or late stage of air conditioning, the cold air may increase the discomfort, such as causing the user to feel cold. Therefore, the user has no choice but to stop the operation of the air conditioning system.

In other words, because the cold or warm air from the air conditioner is blown directly to the user's body, the user feels uncomfortable, which causes the user to frequently turn the air conditioner on or off.

In addition, cold or warm air may cause users to feel drafts, which can also lead to air conditioning sickness.

The foregoing is intended merely to aid in the understanding of the background of the present disclosure, and is not intended to mean that the present disclosure falls within the purview of the related art that is already known to those having ordinary skill in the art.

### SUMMARY

The present disclosure has been made keeping in mind the above problems occurring in the related art, and the present disclosure provides an automotive air vent. In particular, the automotive air vent includes a mesh cover for implementing a no-wind mode. The mesh cover is divided into an upper mesh cover and a lower mesh cover and covers an air vent. When the lower mesh cover is pressed toward the lower portion of a housing of the automotive air vent, it may cause the upper mesh cover to move toward the upper portion of the housing in an associated manner, and the air vent may be caused to move to the front portion of the housing. Accordingly, the effect of switching from the no-wind mode to the normal air vent mode may be achieved. In addition, indoor comfort may be improved by selectively switching between the no-wind mode and a normal vent mode.

According to one embodiment of the present disclosure, an automotive air vent includes: a housing having open front and rear portions; an air vent mounted inside the housing, configured to be movable in a front-to-back direction, and including a blade and a knob for adjusting a wind direction; and a mesh cover installed in a divided manner inside the housing, and configured to cover the air vent so that wind is discharged at a reduced wind speed. The mesh cover is configured to guide the air vent to selectively move forward when the mesh cover is retracted into the housing for switching from a no wind mode to an air vent mode.

In an embodiment, the mesh cover may include: a first mesh cover configured to cover a lower portion of the air vent and move, along a first movement portion of a spacer provided in the housing, to be retracted into the housing; and a second mesh cover configured to cover an upper portion of the air vent and configured to move along a second movement portion of the spacer when the first mesh cover moves to be retracted into the housing.

The first mesh cover may be meshed with the second mesh cover, and when the first mesh cover is retracted into a lower portion of the housing, the first mesh cover works in concert with the second mesh cover to cause the second mesh cover to be retracted into the housing.

In an embodiment, the first mesh cover may include: a first cover body perforated with a plurality of micropores; a first engagement portion extending to both sides of the first cover body and rotatably coupled to the spacer to selectively move along the first movement portion having an arc shape; and a first gear coupled to the first engagement portion and including a plurality of gear teeth facing the second mesh cover.

In an embodiment, the first gear may include a rotational guide provided at a position facing the plurality of gear teeth, protruding to be caught by a stepped portion provided inside the housing, and configured to limit a range of rotation of the first engagement portion.

In an embodiment, the first cover body may include a pressing member configured to cause the first cover body to be retracted into the housing.

In an embodiment, the first mesh cover may further include a pinion gear coupled to the first engagement portion to rotate together with the first engagement portion and meshed with a rack gear provided in the air vent for the movement of the air vent in the front-to-back direction.

In an embodiment, the second mesh cover may include: a second cover body perforated with a plurality of micropores; a second engagement portion extending to both sides of the second cover body and rotatably coupled to the spacer to selectively move along the second movement portion having an arc shape; and a second gear mounted on the second engagement portion and including a plurality of gear teeth facing the first mesh cover.

In an embodiment, the air vent may include a position-fixing device provided on a first surface facing a bottom surface of the housing.

As the air vent moves forward, the position-fixing device may be selectively connected to a pin member provided on the bottom surface of the housing

The position-fixing device may be configured as a closed curve to form a travel path of the pin member, and the pin member may move unidirectionally along the travel path.

As the air vent further moves in response to pulling of the knob in the air vent mode, the pin member connected to the travel path may move out of the travel path, thereby causing the air vent to move backward for switching to the no-wind mode.

In addition, the air vent may include an elastic member connected to the housing and configured to provide an elastic restorative force for the backward movement.

According to another embodiment, an automotive air vent includes: a housing including open front and rear portions; an air vent mounted inside the housing, configured to be movable in a front-to-back direction, and including a blade and a knob for adjusting a wind direction; and a mesh cover including a pinion gear meshed with a rack gear of the air vent. In particular, in response to switching from a no-wind mode to an air vent mode, the pinion gear rotates to guide the air vent to move forward.

In an embodiment, the mesh cover may include: a first mesh cover including the pinion gear and configured to cover a lower portion of the air vent and move, along a first movement portion of a spacer provided in the housing, to be drawn into the housing; and a second mesh cover configured to cover an upper portion of the air vent and configured to move along a second movement portion of the spacer when the first mesh cover moves to be drawn into the housing.

The first mesh cover may be meshed with the second mesh cover, and when the first mesh cover is drawn into a lower portion of the housing, the first mesh cover works in concert with the second mesh cover to cause the second mesh cover to be drawn into the housing.

In an embodiment, the first mesh cover may include: a first cover body perforated with a plurality of micropores; a first engagement portion extending to both sides of the first cover body and rotatably coupled to the spacer to selectively move along the first movement portion having an arc shape; and a first gear coupled to the first engagement portion and including a plurality of gear teeth facing the second mesh cover.

In an embodiment, the first gear may include a rotational guide provided at a position facing the plurality of gear teeth, protruding to be caught by a stepped portion provided inside the housing, and configured to limit a range of rotation of the first engagement portion.

In an embodiment, the second mesh cover may include: a second cover body perforated with a plurality of micropores; a second engagement portion extending to both sides of the second cover body and rotatably coupled to the spacer to selectively move along the second movement portion having an arc shape; and a second gear mounted on the second engagement portion and including a plurality of gear teeth facing the first mesh cover.

The second cover body may move along the second movement portion to be drawn into the housing so as to have a predetermined gap from the rack gear.

According to the present disclosure, in a state where the mesh cover for implementing the no-wind mode is divided into the upper mesh cover and the lower mesh cover and covers the air vent, when the lower mesh cover is pressed to the lower portion of the housing, the upper mesh cover may be caused to move to the upper portion of the housing in an associated manner, and the air vent may be caused to move to the front portion of the housing. Accordingly, the effect of switching from the no-wind mode to the normal air vent mode may be obtained.

Accordingly, the present disclosure may enable selective switching to the no-wind mode or the normal vent mode by manual operation of the user by pressing the lower mesh cover. Therefore, compared to a structure for automatic operation, a relative structural simplification may be realized, and has the effect of providing convenience of mode switching and indoor comfort.

### BRIEF DESCRIPTION OF THE DRAWINGS

The above and other objectives, features, and other advantages of the present disclosure should be more clearly understood from the following detailed description when taken in conjunction with the accompanying drawings, in which:

FIGS. 1 and 2 illustrate an automotive air vent in an air vent mode, according to embodiments of the present disclosure;

FIGS. 3 and 4 illustrate automotive air vent in a no-wind mode, according to embodiments of the present disclosure;

FIG. 5 illustrates the structure of the automotive air vent according to embodiments of the present disclosure;

FIGS. 6A to 6D illustrate the open state of a mesh cover in the automotive air vent according to embodiments of the present disclosure;

FIGS. 7A to 7D illustrate the movement of an air vent in the automotive air vent according to embodiments of the present disclosure; and

FIGS. 8A to 8D illustrate the unfixing of the air vent in the automotive air vent according to embodiments of the present disclosure.

### DETAILED DESCRIPTION

Hereinafter, embodiments of the present disclosure are described in detail with reference to the accompanying drawings.

Advantages and features of the present disclosure, as well as methods of realizing the same, should be more clearly understood from the following detailed description of embodiments when taken in conjunction with the accompanying drawings.

However, the present disclosure is not limited to specific embodiments described hereinafter but may be embodied in a variety of different forms. Rather, these embodiments are provided so that the description of the present disclosure should be complete and fully convey the scope of the present disclosure to a person having ordinary skill in the technical field to which the present disclosure pertains. The present disclosure shall be defined by the scope of the Claims.

Furthermore, in the following description of the present disclosure, a detailed description of known technology or the like has been omitted where it may render the subject matter of the present disclosure unclear.

When a component, device, element, or the like of the present disclosure is described as having a purpose or performing an operation, function, or the like, the component, device, or element should be considered herein as being “configured to” meet that purpose or to perform that operation or function.

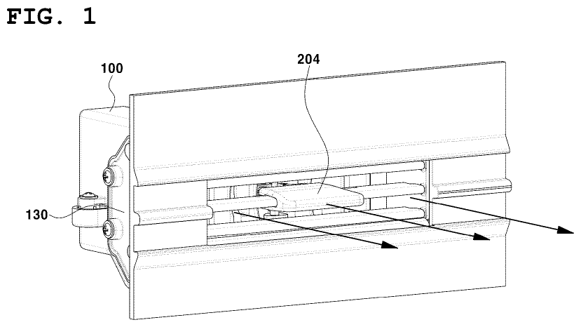

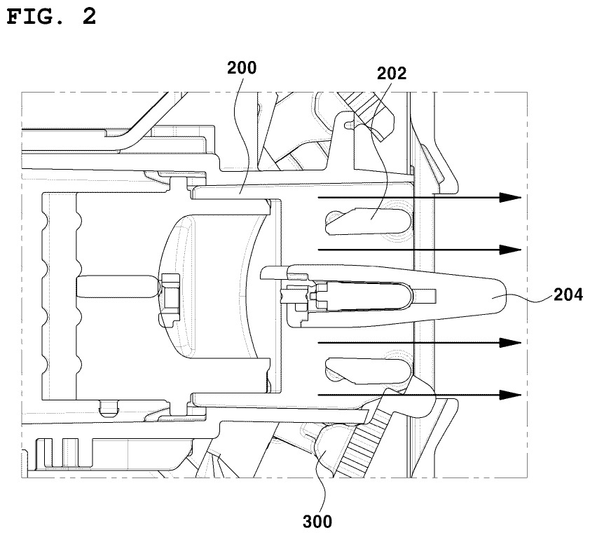

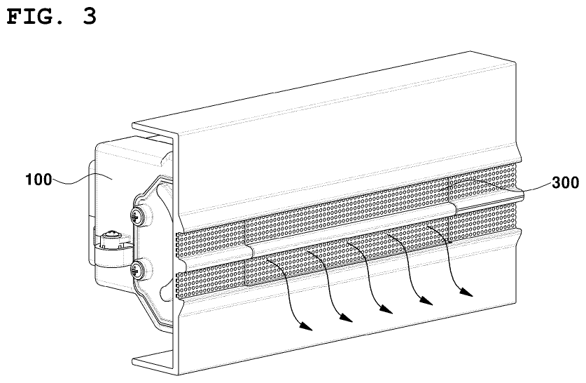

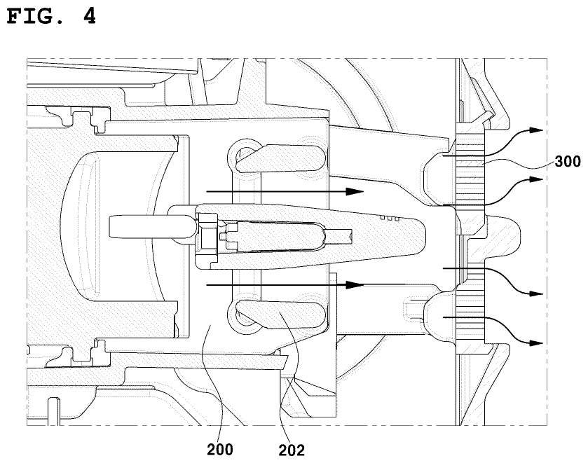

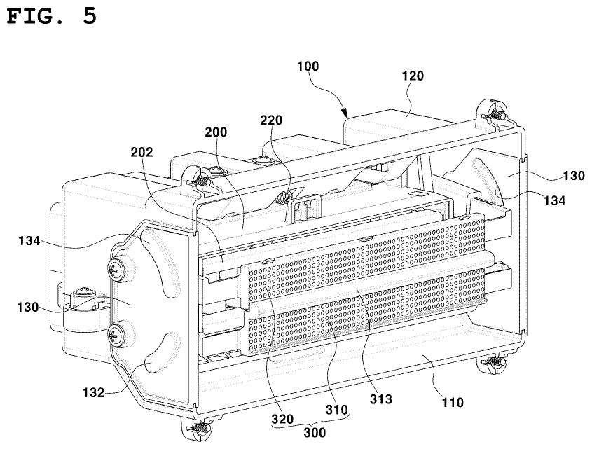

According to embodiments of the present disclosure, FIGS. 1 and 2 illustrate an automotive air vent in an air vent mode, FIGS. 3 and 4 illustrate the automotive air vent in a no-wind mode, and FIG. 5 illustrates the structure of the automotive air vent.

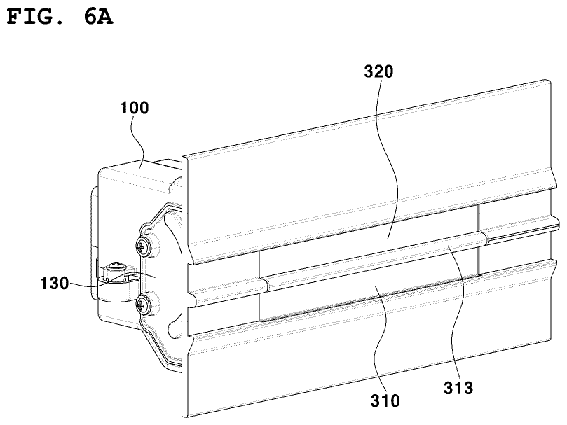

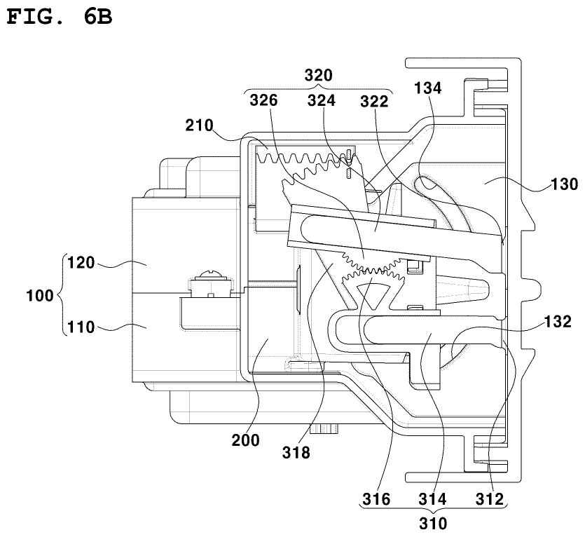

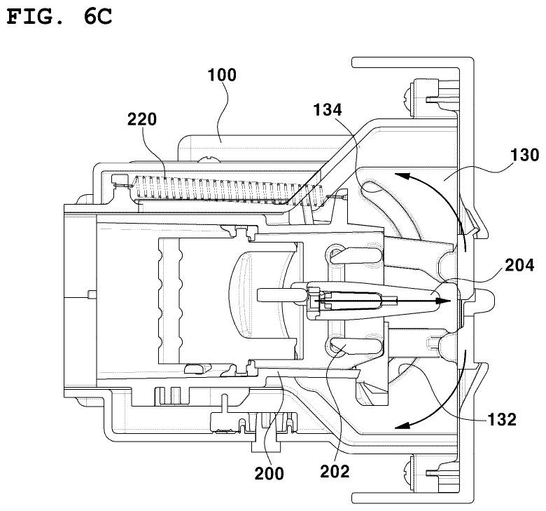

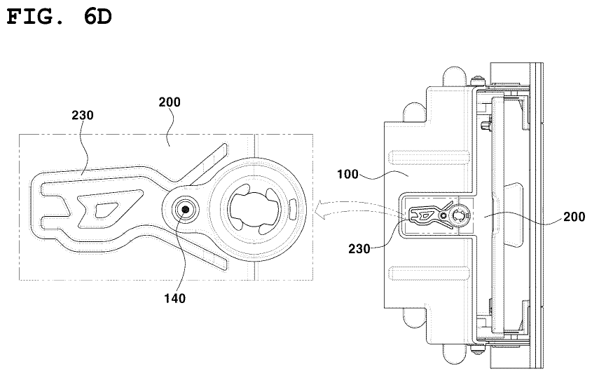

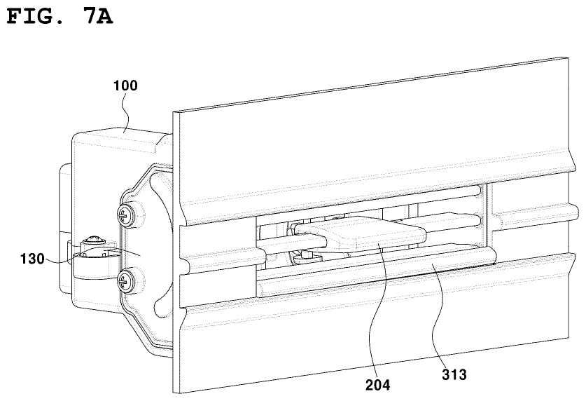

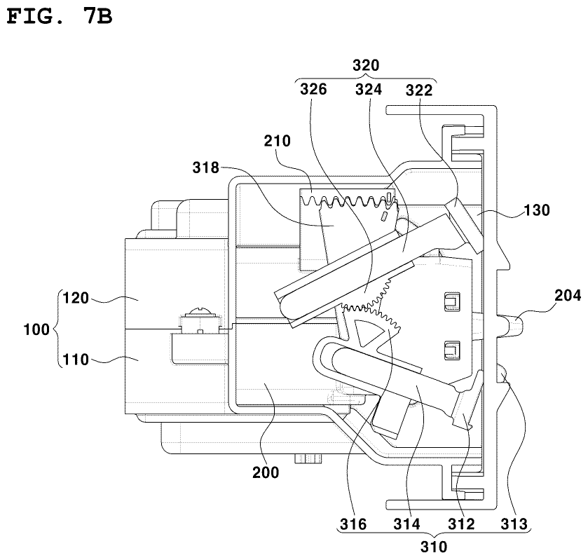

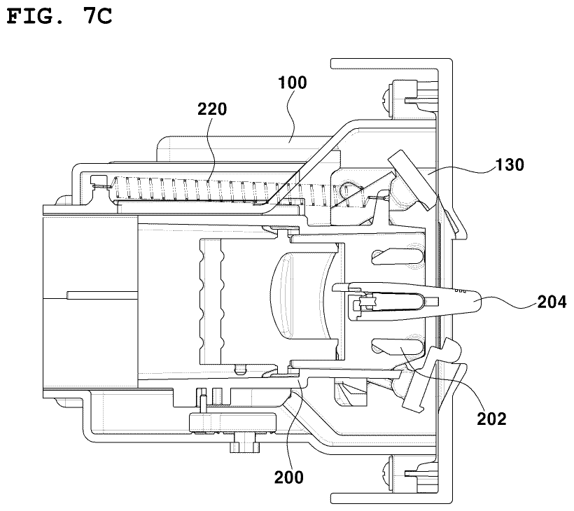

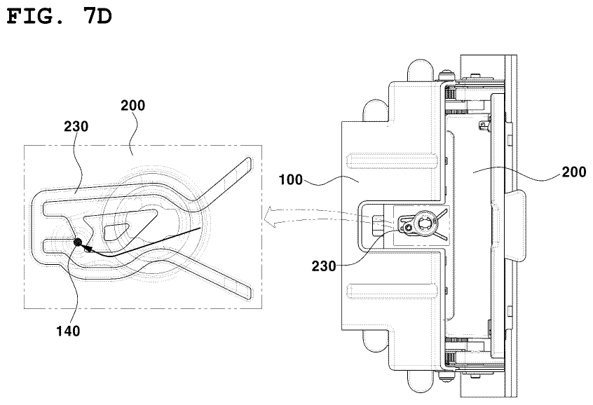

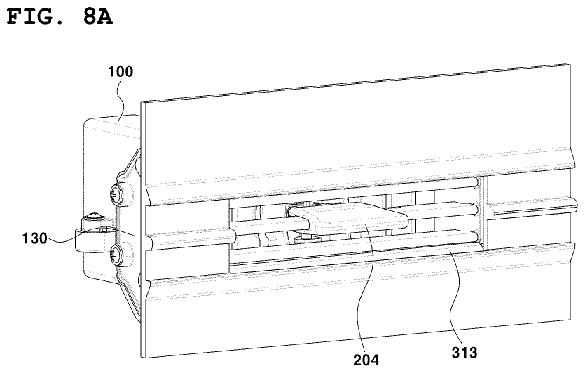

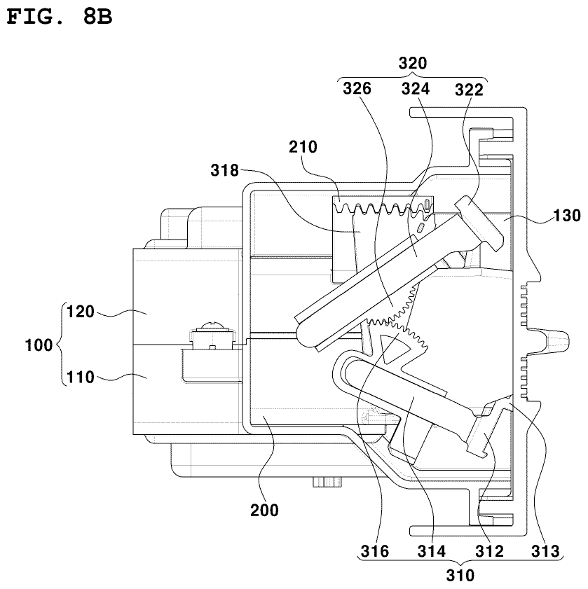

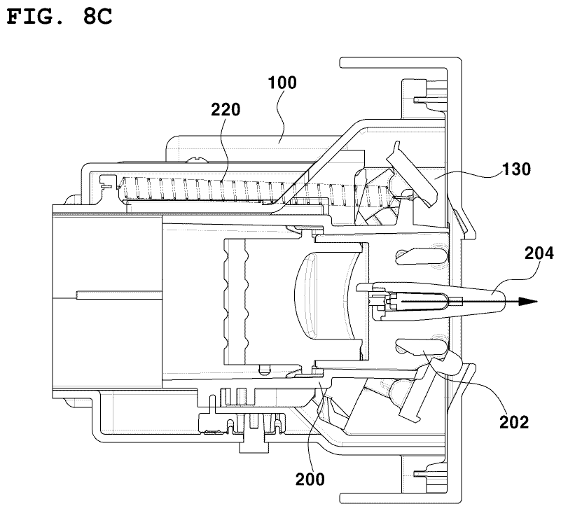

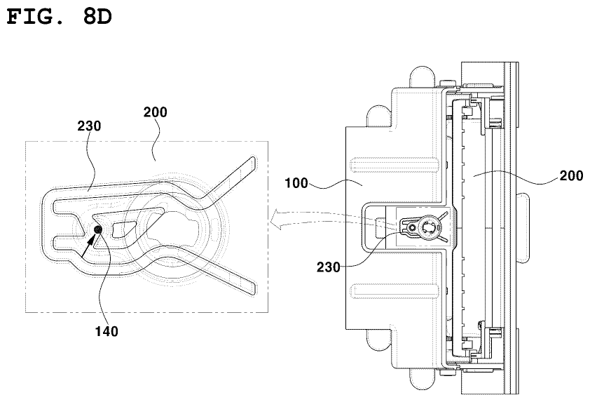

In addition, according to embodiments of the present disclosure, FIGS. 6A to 6D illustrate the open state of a mesh cover in the automotive air vent, FIGS. 7A to 7D illustrate the movement of an air vent in the automotive air vent, and FIGS. 8A to 8D illustrate the unfixing of the air vent in the automotive air vent.

Conventional automotive air vents are mostly wing-type air vents, each of which adjusts the wind direction by changing the angle of the blades by operating a knob.

In such conventional automotive air vents, the outlet is exposed from the front of the cockpit to blow air directly toward the user, which can be unpleasant for some users. This may be uncomfortable for some users who do not want the blowing air.

According to embodiments of the present disclosure, as shown in FIGS. 1 and 2, the air vent mode may be implemented to meet the customer's need for rapid heating. In addition, as shown in FIGS. 3 and 4, the air vent mode may be switched to a no-wind mode to discharge air at a reduced air velocity, thereby also meeting the customer's need for gradual cooling. In other words, a single automotive air vent may simultaneously meet the needs of customers with different preferences.

To realize the above effects, an automotive air vent according to an embodiment may include a housing 100, an air vent 200, and a mesh cover 300, as shown in FIG. 5.

The housing 100 is configured to have open front and rear portions. In one embodiment, the housing 100 is a combination of a lower housing 110 and an upper housing 120.

The air vent 200 is mounted inside the housing 100 and configured to be movable in the front-to-back direction. The air vent 200 includes a blade 202 and a knob 204 configured to adjust the wind direction.

The air vent 200 is provided with an open inlet and an open outlet. The air vent 200 may work in coordination with an air conditioning device (not shown) that supplies air. The air vent 200 may have a hollow shape with open front and rear portions.

The air vent 200 may have a rectangular or polygonal cross-section, but is not limited thereto.

In addition, the air vent 200 may be configured to cool or heat the interior of the vehicle by, for example, selectively allowing air drawn in by the blower unit (not shown) to pass through an evaporator through which refrigerant flows or a heater core through which coolant from the vehicle engine flows to enable heat exchange with the air, and then distributing the cooled or heated air, in various directions, to the vehicle interior through air vents associated with respective parts of the vehicle interior.

These heating and cooling cycles are well known in the art and are not described in detail in this embodiment.

In addition, as shown in FIGS. 6D, 7D, and 8D, the air vent 200 may include a position-fixing device 230 provided on a first surface facing the bottom surface of the housing 100. As the air vent 200 moves forward, the position-fixing device 230 may be selectively engaged with a pin member 140 provided on the bottom surface of the housing 100.

In other words, the position-fixing device 230 is configured as a closed curve to form a travel path for the pin member 140. As the air vent 200 moves forward inside the housing 100, the pin member 140 may move unidirectionally along the travel path and become jammed at a jammed position, thereby causing the position of the air vent 200 to be fixed. In this state, when the air vent 200 is further moved, the pin member 140 may be further moved and disengaged along the movement path in a unidirectional direction, thereby causing the air vent 200 to be unlocked.

The mesh cover 300 is installed in a divided manner inside housing 100 along an up and down direction (i.e., a vertical direction), and covers the air vent 200 in the no-wind mode so that the air can be discharged at a reduced wind speed (see FIGS. 3 and 4).

Here, the mesh cover 300 has a shape corresponding to the front shape of the cockpit and, and it guides the air vent 200 to selectively move forward inside the housing 100 as the mesh cover 300 is retracted into the housing 100 for switching from the no-wind mode to the air vent mode.

In this regard, the mesh cover 300 includes a first mesh cover 310 and a second mesh cover 320.

The first mesh cover 310 covers the lower portion of the air vent 200 and is moved along a first movement portion 132 of the spacer 130 provided in the housing 100 to be retracted into the housing 100.

The first mesh cover 310 includes a first cover body 312, a first engagement portion 314, a first gear 316, and a pinion gear 318.

The first cover body 312 extends in the width direction to correspond to the shape of the air vent 200 and is perforated with a plurality of micropores. The first cover body 312 may cover the lower portion of the air vent 200 in the no-wind mode, thereby allowing the air to be discharged at a reduced wind speed.

In addition, the first engagement portion 314 extends to both sides of the first cover body 312 and is rotatably coupled to the spacer 130 to selectively move along the first movement portion 132 having the shape of an arc.

In addition, as shown in FIGS. 6B, 7B, and 8B, the first gear 316 is configured such that the first engagement portion 314 is coupled thereto to be movable therein and is provided with a plurality of gear teeth facing the second mesh cover 320.

Here, the first cover body 312 may further be provided with a pressing member 313. In one embodiment, when switching from the no-wind mode to the air vent mode, the pressing member 313 may protrude in the width direction of the first cover body 312 to facilitate pressing by a user to bring the first cover body 312 into the housing 100.

The pinion gear 318 is configured to be coupled to the first engagement portion 314 to rotate therewith, and is meshed with a rack gear 210 provided in the air vent 200 for forward and backward movement of the air vent 200 (see FIGS. 6B, 7B, and 8B).

In other words, because the pinion gear 318 is engaged with the rack gear 210 while being fixedly coupled to the first engagement portion 314 at a predetermined inclination, when the first engagement portion 314 is moved by rotation, the pinion gear 318 may move by rotation together with the first engagement portion 314 to move the rack gear 210 forward, thereby causing the air vent 200 to move forward for the air vent mode.

In addition, the second mesh cover 320 covers the upper portion of the air vent 200. As the first mesh cover 310, more particularly, the first cover body 312, moves, the second mesh cover 320 is moved along a second movement portion 134 of the spacer 130 to be retracted into the housing 100.

The second mesh cover 320 includes a second cover body 322, a second engagement portion 324, and a second gear 326.

The second cover body 322 has the same shape as the first cover body 312, is perforated with a plurality of micropores. The second cover body 322 may cover the upper portion of the air vent 200 in the no-wind mode, thereby allowing the air to be discharged together with the first cover body 312 at a reduced wind speed.

In addition, the second engagement portion 324 extends on both sides of the first cover body 312, and is rotatably coupled to the spacer 130 to selectively move along the second movement portion 134 having the shape of an arc.

In addition, as shown in FIGS. 6B, 7B, and 8B, the second gear 326 is mounted on the second engagement portion 324 to protrude therefrom, and is provided with a plurality of gear teeth facing the first gear 316.

In other words, the second gear 326 is meshed with the first gear 316. With this configuration, when the first cover body 312 is moved and drawn into the housing 100 upon pressing of the pressing member 313, the second cover body 322 may work in concert with the first cover body 312 to move in the opposite direction to the first cover body 312 and be retracted into the housing 100.

As described above, when the first cover body 312 is also moved by the second cover body 322, the air vent 200 is also moved forward from the main body by a combination of the pinion gear 318 and the rack gear 210, and the no-wind mode may be switched to the air vent mode.

Here, since the second cover body 322 is configured to have a predetermined gap from the rack gear 210, when the air vent 200 moves forward when switching to the air vent, interference with the rack gear 210 may not occur (see FIG. 7B). Accordingly, problems such as deterioration of operating performance and breakage due to interference may be prevented.

Based on the above-described configuration, the operation of the automotive air vent according to this embodiment is described as follows.

In the no-wind mode, as shown in FIGS. 6A to 6D, the first mesh cover 310 and the second mesh cover 320 cover the lower and upper portions of the air vent 100, respectively. At this time, as shown in FIG. 6C, an elastic member 220, which provides elastic resilience for rearward movement of the air vent 200, is positioned in an initial position (see FIG. 5). In addition, as shown in FIG. 6D, the position-fixing device 230 is positioned in a disconnected state from the pin member 140.

When the pressing member 313 is pressed to draw the first mesh cover 310 into the housing 100 (see FIG. 6A) for switching to the air vent mode, the first engagement portion 314 is caused to rotate about a rotation axis 316a together with the first gear 316, as shown in FIG. 7B. As a result, the first gear 316 causes the second gear 326 to rotate, which in turn causes the second engagement portion 324 to move by rotation, and the second mesh cover 320 is also drawn into the housing 100.

In this case, the first gear 316 may have a rotational guide 317 protruding therefrom. The rotational guide 317 is provided at a position facing a plurality of gear teeth and is configured to be selectively caught by a stepped portion 112 as the first gear 316 rotates (see FIGS. 6B and 7B), thereby limiting the range of rotation of the first engagement portion 314.

At the same time, the rotational movement of the first engagement portion 314 causes the pinion gear 318 to move the rack gear 210. When the front portion of the housing 100 is opened, the air vent 200 is caused to move forward, thereby switching to the air vent mode, as shown in FIG. 7A.

At this time, as shown in FIG. 7C, the elastic member 220 is in a state in which elastic resilience is provided as the air vent 200 moves forward. In addition, as shown in FIG. 7D, the position-fixing device 230 is connected to the pin member 140, and as the pin member 140 is in a jammed position on the travel path, the position of the air vent 200 in the air vent mode is fixed.

In this air vent mode, pulling the front exposed knob 204, as shown in FIG. 8A, causes the air vent 200 to further move forward by about 3 mm. As a result, as shown in FIG. 8D, the pin member 140 also moves out of the travel path of the position-fixing device 230, thereby releasing the position fixing (i.e., a fixed position) the air vent 200.

Here, when the fixed position of the air vent 200 is released, the air vent 200 returns to the initial position due to elastic resilient force exerted by the elastic member 220. The air vent 200 rotates the pinion gear 318 via the rack gear 210 during the movement to the initial position. As the first engagement portion 314 is continuously rotated and moved by the pinion gear 318, the second engagement portion 324 is also rotated and moved. As a result, the first mesh cover 310 and the second mesh cover 320 may be caused to cover the air vent 200, i.e., switching to the no-wind mode is enabled.

According to the present disclosure, the mesh cover for implementing the no-wind mode is divided into the upper mesh cover and the lower mesh cover and covers the air vent. When the lower mesh cover is pressed to the lower portion of the housing, the upper mesh cover may be caused to move to the upper portion of the housing in an associated manner, and the air vent may be caused to move to the front portion of the housing. Accordingly, the effect of switching from the no-wind mode to the normal air vent mode can be achieved.

Accordingly, the present disclosure may enable selective switching to the no-wind mode or the normal vent mode by manual operation of the user, such as pressing the lower mesh cover. Therefore, compared to a structure for automatic operation, a relative structural simplification may be realized, and has the effect of providing convenience of mode switching and indoor comfort.

Although the present disclosure has been described with reference to the some embodiment(s) illustrated in the drawings, it should be apparent to a person having ordinary skill in the art that the embodiments are provided for illustrative purposes only, and that various modifications and alterations can be made without departing from the spirit and scope of the present disclosure. It should also be understood that the entirety or some of the foregoing embodiments may be selectively combined. Accordingly, the true scope and spirit of the present disclosure shall be defined only by the appended claims.

What is claimed is:

1. An automotive air vent comprising:
a housing including open front and rear portions;
an air vent mounted inside the housing, configured to be movable in a front-to-back direction, and comprising a blade and a knob for adjusting a wind direction; and
a mesh cover installed in a divided manner inside the housing and configured to cover the air vent so that wind is discharged at a reduced wind speed, wherein the mesh cover is configured to guide the air vent to selectively move forward when the mesh cover is retracted into the housing for switching from a no-wind mode to an air vent mode.

2. The automotive air vent of claim 1, wherein the mesh cover comprises:
a first mesh cover configured to cover a lower portion of the air vent and move, along a first movement portion of a spacer provided in the housing, to be retracted into the housing; and
a second mesh cover configured to cover an upper portion of the air vent and configured to move along a second movement portion of the spacer when the first mesh cover moves to be retracted into the housing.

3. The automotive air vent of claim 2, wherein the first mesh cover is meshed with the second mesh cover, and when the first mesh cover is retracted into a lower portion of the housing, the first mesh cover works in concert with the second mesh cover to cause the second mesh cover to be retracted into the housing.

4. The automotive air vent of claim 3, wherein the first mesh cover comprises:
a first cover body perforated with a plurality of micropores;
a first engagement portion extending to both sides of the first cover body and rotatably coupled to the spacer to selectively move along the first movement portion having an arc shape; and
a first gear coupled to the first engagement portion and comprising a plurality of gear teeth facing the second mesh cover.

5. The automotive air vent of claim 4, wherein the first gear comprises a rotational guide provided at a position facing the plurality of gear teeth, protruding to be caught by a stepped portion provided inside the housing, and configured to limit a range of rotation of the first engagement portion.

6. The automotive air vent of claim 4, wherein the first cover body includes a pressing member configured to cause the first cover body to be retracted into the housing.

7. The automotive air vent of claim 4, wherein the first mesh cover further comprises a pinion gear coupled to the first engagement portion to rotate together with the first engagement portion and meshed with a rack gear provided in the air vent for the movement of the air vent in the front-to-back direction.

8. The automotive air vent of claim 3, wherein the second mesh cover comprises:
a second cover body perforated with a plurality of micropores;
a second engagement portion extending to both sides of the second cover body and rotatably coupled to the spacer to selectively move along the second movement portion having an arc shape; and
a second gear mounted on the second engagement portion and comprising a plurality of gear teeth facing the first mesh cover.

9. The automotive air vent of claim 1, wherein the air vent comprises a position-fixing device provided on a first surface facing a bottom surface of the housing.

10. The automotive air vent of claim 9, wherein as the air vent moves forward, the position-fixing device is selectively connected to a pin member provided on the bottom surface of the housing.

11. The automotive air vent of claim 10, wherein the position-fixing device is configured as a closed curve to form a travel path of the pin member, and
the pin member moves unidirectionally along the travel path.

12. The automotive air vent of claim 11, wherein as the air vent further moves in response to pulling of the knob in the air vent mode, the pin member connected to the travel path moves out of the travel path, thereby causing the air vent to move backward for switching to the no-wind mode.

13. The automotive air vent of claim 12, wherein the air vent comprises an elastic member connected to the housing and configured to provide an elastic restorative force for the backward movement.

14. An automotive air vent comprising:
a housing including open front and rear portions;
an air vent mounted inside the housing, configured to be movable in a front-to-back direction, and comprising a blade and a knob for adjusting a wind direction; and
a mesh cover comprising a pinion gear meshed with a rack gear of the air vent, wherein in response to switching from a no-wind mode to an air vent mode, the pinion gear rotates to guide the air vent to move forward.

15. The automotive air vent of claim 14, wherein the mesh cover comprises:
a first mesh cover comprising the pinion gear and configured to cover a lower portion of the air vent and move along a first movement portion of a spacer provided in the housing to be drawn into the housing; and
a second mesh cover configured to cover an upper portion of the air vent and configured to move along a second movement portion of the spacer when the first mesh cover moves to be drawn into the housing.

16. The automotive air vent of claim 15, wherein the first mesh cover is meshed with the second mesh cover, and when the first mesh cover is drawn into a lower portion of the housing, the first mesh cover works in concert with the second mesh cover to cause the second mesh cover to be drawn into the housing.

17. The automotive air vent of claim 16, wherein the first mesh cover comprises:
a first cover body perforated with a plurality of micropores;
a first engagement portion extending to both sides of the first cover body and rotatably coupled to the spacer to selectively move along the first movement portion having an arc shape; and
a first gear coupled to the first engagement portion and comprising a plurality of gear teeth facing the second mesh cover.

18. The automotive air vent of claim 17, wherein the first gear comprises a rotational guide provided at a position facing the plurality of gear teeth, protruding to be caught by a stepped portion provided inside the housing, and configured to limit a range of rotation of the first engagement portion.

19. The automotive air vent of claim 16, wherein the second mesh cover comprises:
a second cover body perforated with a plurality of micropores;
a second engagement portion extending to both sides of the second cover body and rotatably coupled to the spacer to selectively move along the second movement portion having an arc shape; and
a second gear mounted on the second engagement portion and comprising a plurality of gear teeth facing the first mesh cover.

20. The automotive air vent of claim 19, wherein the second cover body moves along the second movement portion to be drawn into the housing so as to have a predetermined gap from the rack gear.
